(19) United States
(12) Patent Application Publication
(10) Pub. No.: US 2013/0077818 A1
(43) Pub. Date: Mar. 28, 2013

(54) DETECTION METHOD OF OPTICAL NAVIGATION DEVICE

(71) Applicants: TONG-TEE TAN, Singapore (SG); SRINIVASAN LAKSHMANAN CHETTIAR, Singapore (SG)

(72) Inventors: TONG-TEE TAN, Singapore (SG); SRINIVASAN LAKSHMANAN CHETTIAR, Singapore (SG)

(73) Assignee: LITE-ON SINGAPORE PTE. LTD., MIDVIEW CITY (SG)

(21) Appl. No.: 13/241,207

(22) Filed: Sep. 23, 2011

(51) Int. Cl. G06K 9/00

(52) U.S. Cl. 382/103

(57) ABSTRACT

A detection method of an optical navigation device is disclosed. The device is used for determining whether an object is lifted from the optical navigation device or not. The method includes steps of reading the detection image detected by the optical navigation device, calculating the image signal value thereof during non-lift status, and integrating a historical threshold value with the image signal value according to adaptive factors for generating an adjustment threshold value serving as the navigation threshold of the detection image. The historical threshold value is the navigation threshold of a former detection image of the detection image. A step of comparing the adjustment threshold with the image signal value for determining whether the image signal value passes the navigation threshold or not may also be included. If the image signal value does not pass the navigation threshold, the object is determined as in the lift status.

### BACKGROUND OF THE INVENTION

1. Field of the Invention

The present invention relates to a detection method of a navigation device; in particular, to a detection method of an optical navigation device.

2. Description of Related Art

The conventional optical navigation device may use a predetermined and fixed threshold value to compare and compute with the image data detected by the optical navigation modules, for determining whether there is a user operating the device, and for further determining to start or stop the navigation functions of the device. However, because the user usually cannot maintain the same operation stability from the beginning to the end when using the optical navigation device, the detected image data may vary. Under this situation, using the predetermined and fixed threshold value as the reference for determining whether the user is operating the optical navigation device may generate wrong determination result easily.

### SUMMARY OF THE INVENTION

An embodiment of the present invention discloses a detection method of an optical navigation device. The optical navigation device is used for determining whether an object is lifted from the optical navigation device or not. The method includes steps of reading a detection image detected by the optical navigation device and calculating an image signal value of the detection image. The method further includes a step of comparing the image signal value with a predetermined value, for determining whether the image signal value passes the navigation threshold or not. The threshold value of the navigation threshold is the predetermined value. When the image signal value passes the navigation threshold, the object is determined as in the non-lift status. At the non-lift status, the method further includes steps of reading a next detection image, calculating the image signal value of the next detection image, and comparing the image signal value of the next detection image with the navigation threshold, for determining whether the image signal value of the next detection signal passes the navigation threshold or not. When the object is at the non-lift status, the navigation threshold is an adjustment threshold value generated by integrating a historical threshold value and the image signal value of the next detection image according to an adaptive factor. When the image signal value of the next detection image does not pass the navigation threshold which is configured as the adjustment threshold value, the object is then determined as at the lift status. The historical threshold value is the navigation threshold in correspondence to a former detection image of the detection image corresponding to the adjustment threshold value.

Another detection method of an optical navigation device is disclosed according to an embodiment of the present invention. The optical navigation device is used for determining whether an object is at the lift status or the non-lift status relative to the optical navigation device. The method includes steps of entering an adjustment mode at the non-lift status, reading a detection image detected by the optical navigation device, and calculating an image signal value of the detection image. The method further includes a step of integrating the image signal value with a historical threshold value according to an adaptive factor for calculating the adjustment threshold value in correspondence to the detection image, and the navigation threshold of the detection image is configured as the adjustment threshold value. After that, the adjustment threshold value and the image signal value are compared for determining whether the image signal value passes the navigation threshold or not. When the image signal value does not pass the navigation threshold, the method further includes steps of determining that the object is at the lift status relative to the optical navigation device and entering a buffer mode. The historical threshold value is a navigation threshold in correspondence to a former detection image of the detection image which is read.

On the basis of the above, the detection methods of the optical navigation device disclosed according to the embodiments of the present invention may dynamically adjust the navigation threshold which is used for comparing with the image signal value, in order to precisely determine the statuses of the object relative to the optical navigation device according to the image signal values of different detection images.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram of an optical navigation device according to an embodiment of the present invention;

FIG. 2 shows a block diagram of an optical navigation module according to an embodiment of the present invention;

FIG. 3 shows a relation diagram of the modes of a detection method of an optical navigation device according to an embodiment of the present invention;

FIG. 4 shows a flow chart of a detection method of an optical navigation device according to an embodiment of the present invention; and

FIGS. 5A and 5B show a flow chart of a detection method of an optical navigation device according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

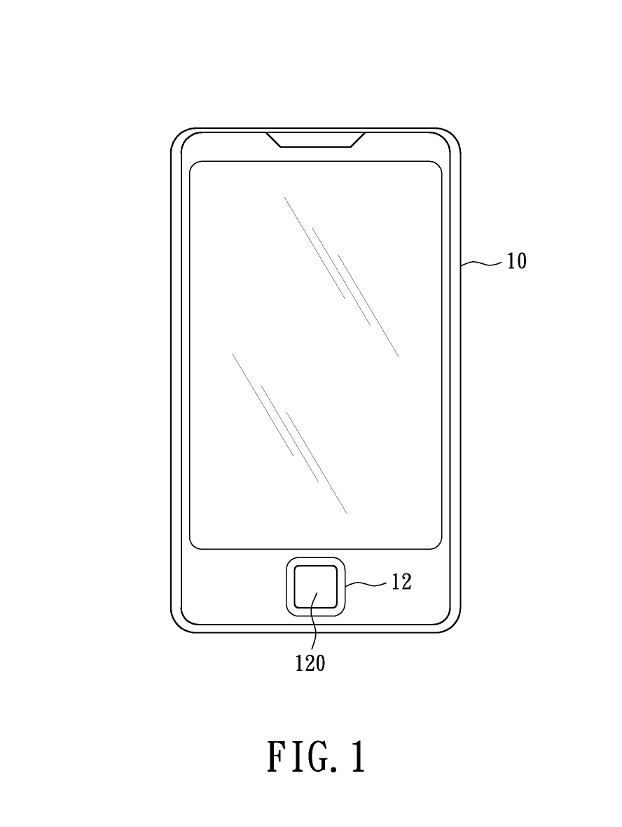

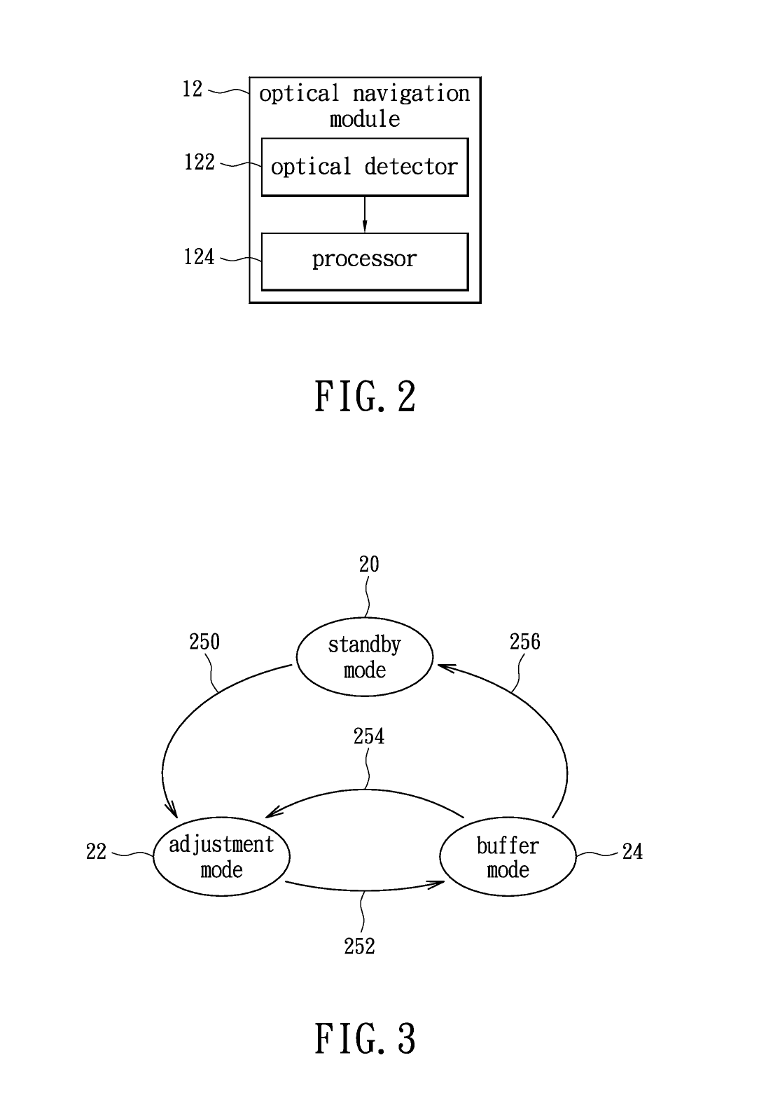

Please refer to FIG. 1 which is a schematic diagram of an optical navigation device 10 according to an embodiment of the present invention. The optical navigation device 10 may be a smart phone having an optical navigation module 12. Particularly, the optical navigation module 12 may be an optical finger navigation module (OFN module). The structure of the optical navigation module 12 includes a contact surface 120 that an object may contact or come close thereto. Please refer to FIG. 2 which is a block diagram of the optical navigation module 12 including an optical detector 122 and a processor 124 according to an embodiment of the present invention. The processor 124 may be used for calculating an image signal value of a detection image, for determining whether the object is at a non-lift status or a lift status relative to the optical navigation device, in order to start or stop the navigation function. For example, assuming that the object is a finger, the lift status may indicate that the finger is detected to leave the contact surface 120 of the optical navigation module 12. The navigation functions may be a function for controlling screen scrolling of the optical navigation device 10 by calculating an amount of image shift between two sequential detection images, etc. The optical detector 122 may be a complementary metal oxide semiconductor (CMOS) sensor, a charge coupled device (CCD) sensor, or the like. The processor 124 may be a digital signal processor (DSP) or a microcontroller (MCU), and so on. The optical detector 122 and the processor 124 may rapidly detect and compute thousands of detection images in a second, for corresponding to the operation of the user and providing navigation functions.

In this embodiment, the image signal value of the detection image may be a pixel average value or image contract value of the detection image which is a value for estimating the image quality. When the object is close to or contacts the optical navigation module 12, because the reflection quantity of infrared lights is relatively high, there may have more pixels closing to white scale among the pixels shown in the gray scale or black white scale of detection image generated by the optical detector 122 by detecting the reflection of infrared lights. Thus, the pixel average value of the detection image is relatively high. In addition, the pixel difference between the pixels of the object and the pixels of background is relatively high, which increases the contract of the detection image and generates higher image contract value. On the other hand, if there is no object coming close to the optical navigation module 12, the reflection quantity of infrared lights may be relatively small, which also makes the pixel average value of the corresponding detection image small. Moreover, the difference between the pixels of the detection image and the image contract value may also be relatively small.

Therefore, the processor 124 may compare image signal value in correspondence to the detection image generated by optical detector 122 with the threshold value of the navigation threshold, for determining whether there is an object contacting or leaving the optical navigation module 12 of optical navigation 10, and further determines whether the object is at the lift status or the non-lift status. For example, if the processor 124 calculates that the image signal value of the detection image generated by the optical detector 122 passes the navigation threshold, that means there is an object coming close to or contact the optical navigation module 12. For instance, there may be a finger of the user placed on the contact surface 120 (see FIG. 1) of the optical navigation module 12. At the moment, the processor 124 may determine that the object is at the non-lift status and start the navigation functions. For example, the processor 124 may determine that the action of the navigation functions which should be executed is scrolling, clicking, or dragging according to the changes of the following detected detection images. After the processor 124 calculates that the image signal value of the captured detection image does not pass the navigation threshold, the object may be determined as at the lift status and the navigation functions may be stopped.

Because the smoothness of the objects which are used for contacting the optical navigation module 12 may be different, and the stability when the same object is moving along the optical navigation module 12 may vary frequently, thus the image quantity of the detection images generated by the optical detector 122 may be different from one another. Therefore, if the processor 124 uses a single and fixed threshold value for determining whether to execute the navigation functions or not by comparing the threshold value with the image signal value, the determination result may be wrong. For example, the finger of the user may contact the contact surface 120 of the optical navigation module 12, however, when the finger of the user is moving on the contact surface 120, the contact surface between the finger and the contact surface 120 may vary, which makes the image signal value of the detection image change between high and low frequently. Therefore, when the image signal value is relative low, the processor 124 may mistakenly determine that the image signal value does not pass the navigation threshold, and thus stop the navigation functions incorrectly even when the finger is still moving on the contact surface 120.

Therefore, in this embodiment, the processor 124 may execute a set of code for adjusting the threshold value of the navigation threshold according to the changes of image signal value of the following captured detection images. The processor 124 may also sensitively determine whether the object leaves the contact surface 120 of the optical navigation module 12 or not. For example, the processor 124 may determine whether the user lifts his finger from the contact surface 120, for starting or stopping the navigation functions immediately.

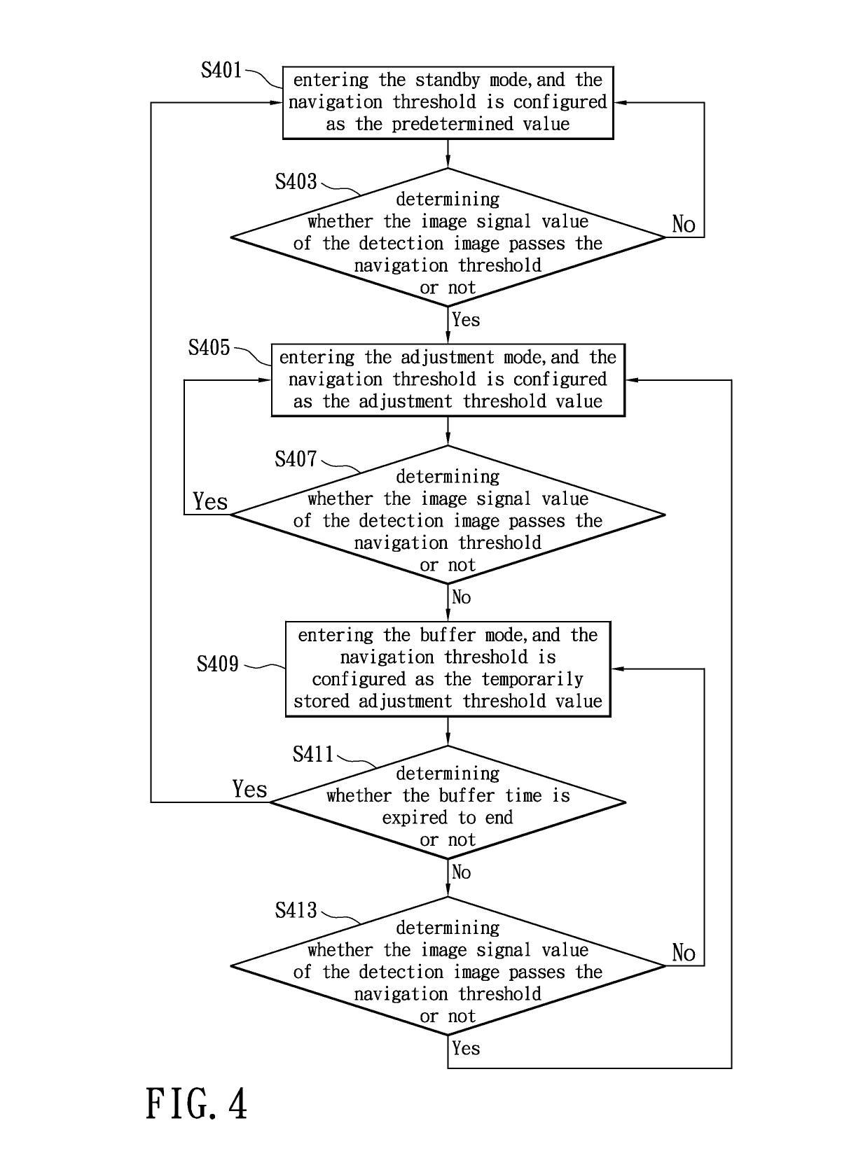

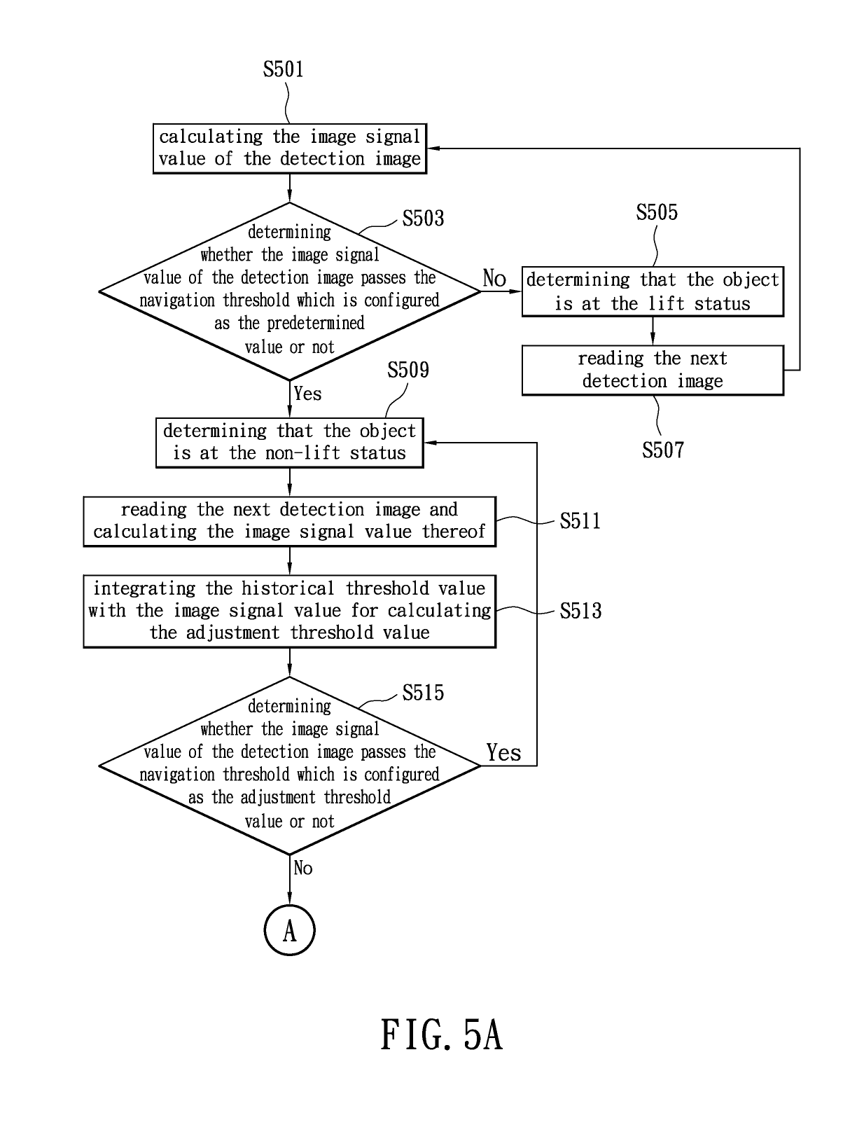

Please refer to FIG. 3 and FIG. 4. FIG. 3 is a relation diagram of the navigation modes corresponding to different image quality of the detection images, and each navigation mode is corresponding to different calculation manners of the navigation threshold. The navigation modes in this embodiment include a standby mode 20, an adjustment mode 22, and a buffer mode 24. FIG. 4 is a flow chart of a detection method of the processor 124 for determining whether the object is at the non-lift status or the lift status relative to the optical navigation device 10.

Initially, when the navigation functions are not started and the manner of the processor 124 for calculating the navigation threshold is corresponding to the standby mode 20 (S401), the processor 124 (see FIG. 2) may set the threshold value of the navigation threshold as a predetermined value and sequentially calculate the image signal values of a plurality of the detection images detected by the optical detector 122, for determining whether the image signal values pass the navigation threshold value in the standby mode 20 (S403). The navigation threshold is a criterion for determining whether the object contacts the optical navigation module 12. The predetermined value may be a value in correspondence to the type of the image signal values. For example, when the image signal value is an average value of the detection image, the predetermined value may be a particular pixel average value which is estimated and calculated according to statistic data. In other words, the processor 124 may determine whether the image signal value of each detection image is greater than or equals to the predetermined value or not by comparing the image signal value with the predetermined value. Thus, the processor 124 may be able to determine whether there is an image signal value in correspondence to the detection image passes the navigation threshold under the standby mode 20.

When the processor 124 calculates image signal values of detection images in sequence and determines that there is an image signal value of one of the detection image (such as detection image a₁) is greater or equals to the predetermined value, it indicates that there is an object touching the contact surface 120 of the optical navigation module 12 during the period which the detection image a₁ is detected. Thus, the processor 124 determines that the object is at the non-lift status. At the moment, the processor 124 may start the navigation functions and enter the adjustment mode 22 (which corresponds to the indication direction 250 in FIG. 3) (S405). 10022] After entering the adjustment mode 22, the processor 124 may dynamically adjust the navigation threshold which is used for comparing with the image signal values, thus the navigation threshold value is no longer a constant value. In this embodiment, after the processor 124 determines that the object is at the non-lift status and changes from the standby mode 20 to the adjustment mode 22, the processor 124 may continuously read and calculate the image signal value of the following detection image (such as a detection image a₂ next to the detection image a₁). Then the processor 124 may calculate and integrate the image signal value of the detection image a₂ with a historical threshold value according to an adaptive factor, for generating an adjustment threshold value in correspondence to the detection image a₂. The processor 124 may use the adjustment threshold value as the navigation threshold for comparing it with the image signal value of the detection image a₂, in order to determine whether the image signal value of the detection image a₂ passes the navigation or not (S407). The historical threshold value may be a threshold value which has been used for comparing with the former detection image. In the aforementioned example, the historical threshold value in correspondence to the detection image a₂ is the threshold value being used for comparing with the image signal value of the detection image a₁, which is the predetermined value in this example.

The adaptive factors may include an adaptive ratio for configuring the proportions between the historical threshold value and the image signal value in the adjustment threshold, and the proportion of the historical threshold value is greater than the proportion of the image signal value. For example, the ratio of the historical threshold value to the image signal value may be 3 to 1. Therefore, the magnitude of the adjustment threshold value of the detection image a₂ is influenced by a historical data (historical threshold value) and a real time data (image signal value), and the influence degree of the historical data is greater than the real time data.

When the image signal value of the detection image a₂ passes the navigation threshold, the processor 124 may determine that the object is still at the non-lift status, thus the navigation functions may be continuously provided. In addition, the processor 124 may read another detection image next to the calculated one (such as a following detection image a₃ next to the detection image a₂), and may calculate and compare the image signal value of the detection image a₃ and the adjustment threshold value in correspondence to the detection image a₃, for determining whether the detection image a₃ passes the corresponding adjustment threshold value. In the present embodiment, the adjustment threshold value corresponding to the detection image a₃ is generated by integrating the adjustment threshold value of the detection image a₂ (which serves as the historical threshold value of the detection image a₃) with the image signal value of the detection image a₃ according to the adaptive ratio (which is 3 to 1 as exemplarily described above).

The following actions including calculation and determination of other detection images executed by the processor 124 may be deduced by analogy according to the aforementioned description. When the image signal value passes the navigation threshold in correspondence to said detection image, the processor 124 may determine that the object is at the non-lift status and may continuously execute the navigation functions.

However, if the processor 124 determines that the image signal value of one of the detection images (such as a detection signal a₄ next to the detection image a₃) does not pass the corresponding navigation threshold, the processor 124 may determine that the object is at the lift status. For example, when the average value of pixels captured by the detection image a₄ reduces, or the contract value of the detection image a₄ decreases to be lower than the navigation threshold, it indicates that the finger of the user lifts and leaves the contact surface 120. At the moment, the processor 124 enters a buffer mode 24 (in correspondence to the indication direction 252 in FIG. 3) (S409).

When entering into the buffer mode 24, the processor 124 may temporarily store the last adjustment threshold value calculated before the object changed from the non-lift status into the lift status. For example, the adjustment threshold value in correspondence to the detection image a₃. The adjustment threshold value may be temporarily stored in a register (not shown in FIGS. 1 and 2) of the optical navigation device 10, and the stored adjustment threshold value may serve as the navigation threshold under the buffer mode 24. At the same time, because the processor 124 determines that the object has left the contact surface 120, it means that there is no need to execute the navigation functions. Thus the processor 124 may stop the execution of the navigation functions and start to count time according to a buffer time.

When the processor 124 is in the buffer mode 24, it may continuously do time counting and determine whether the buffer time is expired to end (S411). Before the buffer time is expired, the image signal values of the following detection images (such as a detection image a₅ next to the detection image a₄) may still be read and calculated, and the image signal value may be compared and determined to pass the navigation threshold or not (S413). Before the buffer time is expired to end, if there is a image signal value of the detection image passing the navigation threshold, the processor 124 may determine that the object is at the non-lift status again, and may go back to adjustment mode 22 (which corresponds to the indication direction 254 in FIG.3) (S405). The adjustment threshold values of the following detection images may be calculated according to the adaptive factor, and the processor 124 may determine whether the image signal value of the detection signal passes the navigation threshold or not for further determining whether to execute the navigation functions or not (S407).

Please refer back to the step of counting the buffer time under the buffer mode 24 (S411). The processor 124 sequentially compares the image signal values of the detection images with the adjustment threshold value which serves as the navigation threshold and is temporarily stored in the register till the buffer time is expired to end. If the processor 124 does not find any image signal value passes the navigation threshold of the buffer mode 24 for going back to the adjustment mode 22 during the period of buffer mode 24, it means that the object does not touch the contact surface 120 again during the period defined by the buffer time after lifting the contact surface 120. That is, at the moment, the user may stop operating the optical navigation device 10, thus the processor 124 may determine to go back to the standby mode 20 in the step S401 (which corresponds to the indication direction 256 of FIG. 3). After that, the navigation threshold may be reset to the initial value, for starting the navigation functions again at the next time when there is an object touches the contact surface 120.

By using different calculation manners corresponding to different modes for comparing the image signal values with the threshold values, the navigation threshold may be adjusted immediately for delicately and precisely adapting to the situation between the object and the optical navigation module. For example, when the object is a finger, once the processor 124 starts the navigation functions according to the first image signal value which passes the predetermined value, the navigation threshold may then be immediately adjusted according to the dynamical operation on the contact surface 120 via the user's finger. Therefore, whether to start or stop the navigation functions may be precisely corresponded to the action of contacting the contact surface 120 or leaving the contact surface 120 using the user's finger. Accordingly, wrong determinations which are caused by using a single and fixed navigation threshold may be avoided.

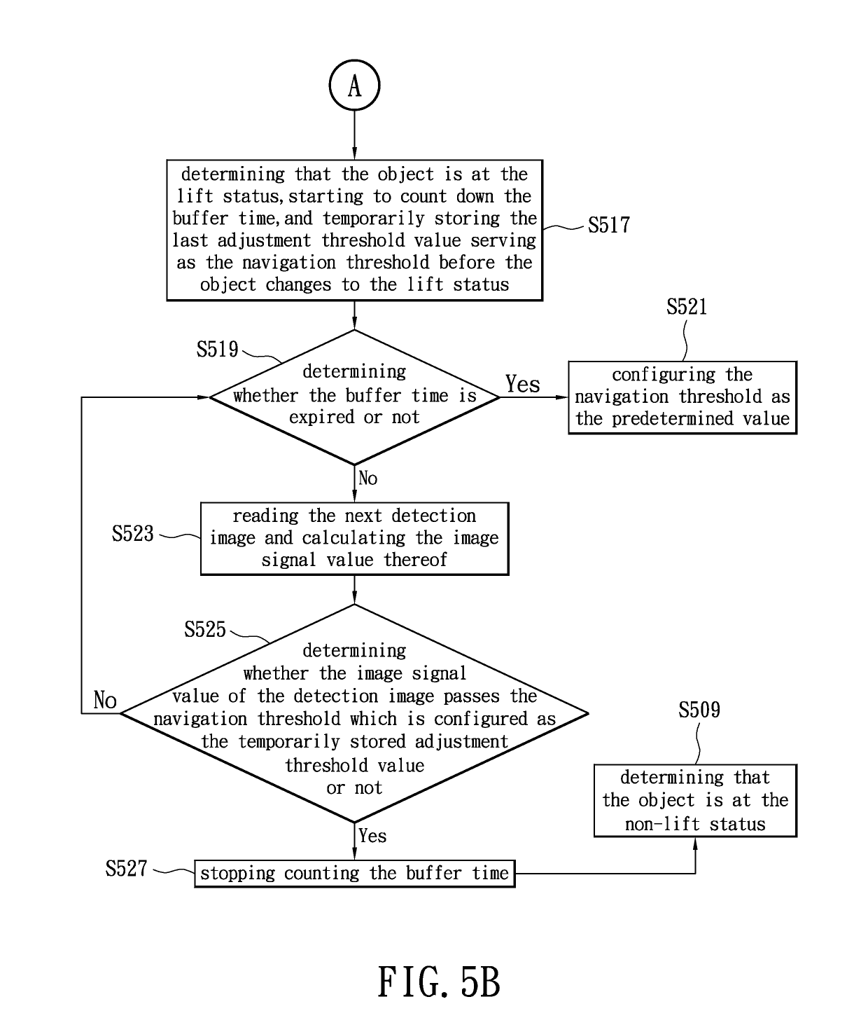

Please refer to FIGS. 5A and 5B which illustrate a flow chart of a detection method of an optical navigation device according to an embodiment of the present invention, and please refer to FIGS. 1 and 2 associated with FIGS. 5A and 5B.

Please refer to FIG. 5A first. In this embodiment, the optical detector 122 may continuously detect the reflection of lights and generate several detection images after the optical navigation device 10 is turned on. The processor 124 continuously receives the detection images and calculates the image signal values of the detection images. After the processor 124 reads and calculates the image signal value of one of the detection images (S501), the image signal value is then compared with the navigation threshold. After the optical navigation device 10 is turned on and before the first time when the navigation functions are executed, the object (such as a finger) may be determined as in the lift status and the navigation threshold may be set as a predetermined value. The processor 124 may compare the image signal value with the predetermined value for determining whether the image signal value passes the navigation threshold under the standby mode (S503).

If the determination result shows that the image signal value does not pass the navigation threshold, the processor 124 may determine that the object is at the lift status (S505), and may read the next detection image (S507), for continuously calculating the image signal value of the detection image (that is, the procedure may go back to the step S501), and for expecting to find an image signal value which passes the navigation threshold. On the other hand, if the determination result shows that the image signal value passes the navigation threshold which equals to the predetermined value, the processor 124 may determine that the object is at the non-lift status (S509). After that, the processor 124 may control to execute the navigation functions, and control the display screen of the optical navigation device 10 to move correspondingly.

After the object enters the non-lift status, the processor 124 may continuously read and calculate the image signal value of the next detection image (S511). In addition, the processor 124 may integrate a historical threshold value with the presently calculated image signal value according to an adaptive factor, for calculating an adjustment threshold value (S513), and for serving as the navigation threshold of the next detection image which is read in step S511. The historical threshold value has been described in the aforementioned embodiments. The processor 124 compares the image signal value calculated in step S511 with the adjustment threshold value calculated in step S513, for determining whether the image signal value passes the navigation threshold which has the value equaling to the adjustment threshold value (S515).

If the image signal value of the detection image passes the corresponding navigation threshold, the processor 124 may goes back to the step S509, for determining that the object is still at the non-lift status, as shown in FIG. 5A. Then the processor 124 may read a further next detection image, and calculate and determine whether the image signal value of the further next detection signal passes the corresponding navigation threshold. It is worth noting that the historical threshold value suitable to the present adjustment threshold value may be the adjustment threshold used by the former detection image.

The adaptive factor in this embodiment may include an adaptive ratio and a weight value, in which the adaptive ratio is described in the aforementioned embodiments. The adjustment threshold value may be changed smoothly according to historical data by setting the proportion of the historical threshold value higher than the that of the image signal value in the adaptive ratio, thus may prevent the adjustment threshold value from being dramatically influenced by a single real time data.

The weight value is a value between 0 and 1, which is used for weighting the threshold value generated by calculating the historical threshold value with the image signal value according to the adaptive ratio, in order to generate the adjustment threshold value in this embodiment. Because the weight value is smaller than 1, the weighted adjustment threshold value may be slightly smaller than the value which generated by integrating the historical threshold value with the image signal value. After that, the relative smaller adjustment threshold value may let the image signal value of the detection images have higher possibility to pass the navigation threshold. Therefore, the image signal values of the following detection images may not easily become smaller than the navigation threshold when the image signal values of the following detection images are just slightly decreasing, which prevents the processor 124 from wrongly determining that the object is entering the lift status.

After the step of determining whether the image signal value passes the navigation threshold which equals to the adjustment threshold value (S515) as shown in FIG. 5A, if the image signal value of the detection image decreases drastically and thus does not pass the navigation threshold, the processor 124 may determine that the object changes to the lift status and may start time counting according to the length of the buffer time, as illustrated in FIG. 5B. At the same time, the last adjustment threshold value calculated before the object changing from the non-lift status to the lift status is temporarily stored in the register (not shown), for configuring the navigation threshold as the stored adjustment threshold value (S517). The buffer time may be different according to the design scheme of the optical navigation device, which may be a few milliseconds or a few seconds.

Reference is made to FIG. 5B. When the object changes from the non-lift status to the lift status, the processor 124 may continuously determine that the buffer time is expired to end or not (S519). When the buffer time is expired to end, the navigation threshold may be configured back to the initial value which equals the predetermined value (S521), thus the optical navigation device 10 may be recovered to the initial standby status. But if the buffer time is not expired to end, the processor 124 may read the following detection images and calculate the image signal values thereof (S523). After that, the processor 124 may compare the image signal value calculated in step S523 with the adjustment threshold value which is temporarily stored in step S517, for determining whether the image signal value of the detection image passes the navigation or not (S525).

If the compared image signal value of the detection image does not pass the navigation threshold, the processor 124 may goes back to the step S519 for determining whether the buffer time is expired to end or not, and read the following detection images before the buffer time is expired (S523). Under the situation that the buffer time is not expired, the processor 124 may compare the image signal value with the same adjustment threshold value again (S525). The time counting may be executed until one of the image signal values passes the navigation threshold (S527). After that, the method may go back to the step S509 which determines that the object changes from the lift status to the non-lift status again, for dynamically adjusting the value of the navigation threshold according to different image signal value.

According to the embodiments of the present invention, the aforementioned optical navigation device and the detection method thereof may provide a manner which is different from using a single and fixed threshold value for detecting that the object is contacting or lifting the optical navigation device. According to the embodiments of the present invention, once after the object passes the comparison according to the predetermined value and is determined to contact the optical navigation device for operating it, the navigation threshold may be dynamically adjusted for adapting to the real situation that the image signal value may change frequently when the object contacts to the optical navigation device. Therefore, slight changes of the image signal value may not generate wrong determination results illustrating that the object leaves the optical navigation device, which prevents the navigation functions from being wrongly started or stopped.

In addition, by adjusting the occupation ratios of the historical threshold value and the image signal value, which makes the ratio of the historical threshold value higher than the ratio of the image signal value, the adjustment threshold value may be influenced by the historical threshold value more than the image signal value, for preventing the generated adjustment threshold value from changing dramatically by giving undue emphasis to the newest image signal value. Moreover, by using the weight value for adjusting the adjustment threshold value, the adjustment value may be smaller than the image signal value in most cases, thus the navigation functions may stay working as far as possible, for carrying out the operations of the object. The schemes described above may also prevent the navigation functions from being stopped because of slight decrease of the image signal value.

Furthermore, even when the image signal value of the detection image is smaller than the navigation threshold, the embodiments of the present invention may reserve a buffer time. During the buffer time, the navigation threshold may still be configured the same as the adjustment threshold value rather than changes back to predetermined value, which matches the user operation which may repeatedly lift up or put down on the object (such as a finger) on the contact surface. That is, when the object is leaving the contact surface, which makes the image signal value reduce obviously, but with an extremely short period, the optical navigation device may still determine the image signal value according to the threshold value calculated according to the historical data. Therefore, the wrong determination caused by shortly removing user's finger from the contact surface and thus stops the optical navigation threshold may be eliminated.

Just when the buffer time is expired but the image signal value of the detection image still does not rise back to the degree passing the navigation threshold, the user may be determined not to operate the optical navigation device, and the navigation threshold value may be configured back to the initially predetermined value. Thus when the same or different user operates the optical navigation device again, the navigation threshold may still be able to change according to the operation styles of the users.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims

What is claimed is:

1. A detection method of an optical navigation device for determining whether an object is at a lift status or a non-lift status relative to the optical navigation device, the method comprising:
reading a detection image detected by the optical navigation device and calculating an image signal value of the detection image;
comparing the image signal value with a predetermined value, for determining whether the image signal value passes a navigation threshold or not, wherein a threshold value of the navigation threshold is the predetermined value;
when the image signal value passes the navigation threshold, determining that the object is at the non-lift status;
reading a next detection image and calculating the image signal value of the next detection image at the non-lift status;
comparing the image signal value of the next detection image with the navigation threshold for determining whether the image signal value of the next detection image passes the navigation threshold or not, wherein when the object is at the non-lift status, the threshold value of the navigation threshold is an adjustment threshold value generated by integrating a historical threshold value with the image signal value of the next detection image according to a adaptive factor; and
when the image signal value of the next detection image does not pass the navigation threshold which is configured as the adjustment threshold value, determining that the object is at the lift status;
wherein the historical threshold value is the navigation threshold of a former detection image of the detection image which corresponds to the adjustment threshold value.

2. The detection method according to claim 1, wherein after determining the object is at the lift status, the method further comprises:
counting time according to a buffer time;
determining whether the buffer time is expired to end or not;
when the buffer time is not expired to end, reading a further next detection image and calculating the image signal value of the further next detection image;
comparing the image signal value of the further next detection image with the navigation threshold for determining whether the image signal value of the further next detection image passes the navigation threshold or not, wherein under a situation that the buffer time is not expired to end and the object is at the lift status, the navigation threshold is the last adjustment threshold value calculated before the object changed from the non-lift status to the lift status;
when the image signal value passes the navigation threshold, determining that the object is at the non-lift status; and
when the buffer time is expired to end, configuring the navigation threshold as the predetermined value for comparing with following detection images.

3. The detection method according to claim 2, wherein after comparing the image signal value of the next detection image when the buffer time is not expired to end, the method further comprises:
when the image signal value does not pass the navigation threshold, returning to determine whether the buffer time is expired to end or not.

4. The detection method according to claim 1, wherein after the image signal value of the next detection image passes the navigation threshold when the object is at the non-lift status, the method further comprises:
returning to read the next detection image and calculating the image signal value of the next detection image during the non-lift status.

5. The detection method according to claim 1, wherein the adaptive factors includes an adaptive ratio and a weight value, wherein the adaptive ratio is used for configuring proportions between the historical threshold value and the image signal value in the adjustment threshold value, and the proportion of the historical threshold value is greater than the proportion of the image signal value, and the weight value is used for weighting a result of integrating the historical threshold value with the image signal value according to the adaptive ratio.

6. The detection method according to claim 5, wherein the weight value is smaller than 1.

7. The detection method according to claim 1, wherein the image signal value is a pixel value or a contrast value of the detection image.

8. A detection method of an optical navigation device which is used for determining whether an object is at a lift status or a non-lift status relative to the optical navigation device, the method comprising:
entering an adjustment mode, reading a detection image detected by the optical navigation device, and calculating an image signal value of the detection image at the non-lift status;
integrating a historical threshold value with the image signal value according to an adaptive factor, for calculating an adjustment threshold value in correspondence to the detection image, wherein the adjustment threshold value serves as a navigation threshold of the detection image;
comparing the adjustment threshold value with the image signal value, for determining whether the image signal value passes the navigation threshold or not; and
when the image signal value does not pass the navigation threshold, determining that the object is at the lift status and entering a buffer mode;
wherein the historical threshold value is the navigation threshold in correspondence to a former detection image of the detection image which is read.

9. The detection method according to claim 8, wherein after entering the buffer mode, the method further comprises:
temporarily storing the last adjustment threshold value which is calculated before the object changing from the non-lift status to the lift status, and counting time according to a buffer time;
determining whether the buffer time is expired to end or not;
when the buffer time is not expired to end, reading and calculating the image signal value of a next detection image, and comparing the image signal value with the navigation threshold, for determining whether the image signal value passes the navigation threshold or not, wherein the navigation threshold is the temporarily stored adjustment threshold value; and
when the image signal value passes the navigation threshold, stop counting the buffer time, and determining that the object is at the non-lift status and returning to the adjustment mode.

10. The detection method according to claim 9, wherein after comparing the image signal value with the navigation threshold when the buffer time is not expired to end, the method further comprises:
when the image signal does not pass the navigation threshold, returning to determine whether the buffer time is expired to end or not.

11. The detection method according to claim 9, wherein after determining whether the buffer time is expired to end or not, the method further comprises:
when the buffer time is expired to end, configuring the navigation threshold as a predetermined value, and entering a standby mode.

12. The detection method according to claim 11, further comprising:
reading a further next detection image and calculating the image signal value of the further next detection image at the standby mode;
comparing the image signal value with the navigation threshold, for determining whether the image signal value passes the navigation threshold or not, wherein the navigation threshold is the predetermined value;
when the image signal passes the navigation threshold, determining that the object is at the non-lift status; and
entering the adjustment mode;
wherein the detection image read after entering the adjustment mode is next to the detection image which passes the navigation threshold at the standby mode.

13. The detection method according to claim 8, wherein after comparing the adjustment threshold value with the image signal value, the method further comprises:
when the image signal value passes the navigation threshold, determining that the object is still at the non-lift status relative to the optical navigation device;
reading and calculating the image signal value of a next detection image; and
returning to calculate the adjustment threshold value.

14. The detection method according to claim 8, wherein the adaptive factors includes an adaptive ratio and a weight value, wherein the adaptive ratio is used for configuring proportions between the historical threshold value and the image signal value in the adjustment threshold value, and the proportion of the historical threshold value is greater than the proportion of the image signal value, and the weight value is used for weighting a result of integrating the historical threshold value with the image signal value according to the adaptive ratio.

15. The detection method according to claim 14, wherein the weight value is smaller than 1.

16. The detection method according to claim 8, wherein the image signal value is a pixel value or a contrast value of the detection image.
